(19) United States
(12) Patent Application Publication
(10) Pub. No.: US 2021/0404474 A1
(43) Pub. Date: Dec. 30, 2021

(54) TAPERED THRUST BEARING FOR PUMPING SYSTEM

(71) Applicant: Halliburton Energy Services, Inc., Houston, TX (US)

(72) Inventors: Thomas John Gottschalk, Houston, TX (US); Jason Eugene Hill, Catoosa, OK (US); Wesley John Nowitzki, Tulsa, OK (US)

(21) Appl. No.: 16/497,707

(22) PCT Filed: Dec. 26, 2018
(86) PCT No.: PCT/US18/67498

§ 371 Date: Sep. 25, 2019

(51) Int. Cl. F04D 13/10; F04D 3/00; F04D 29/046

(52) U.S. Cl. CPC F04D 13/10; F04D 29/046; F04D 3/00

(57) ABSTRACT

A system includes a drive shaft and a diffuser positioned around the drive shaft to transmit a flow of fluid. The system also includes an impeller that is rotatable with the drive shaft to induce the flow of fluid through the diffuser. Additionally, the system includes a tapered thrust bearing positionable to receive a downhole force from a pumping stage. The tapered thrust bearing includes a flange sleeve positioned around the drive shaft. The flange sleeve includes a tapered mating surface. The tapered thrust bearing also includes a stationary bushing positioned around the flange sleeve. The stationary bushing includes a tapered receiving surface to receive the tapered mating surface of the flange sleeve.

### TECHNICAL FIELD

The present disclosure relates to a tapered thrust bearing for a pumping system. More specifically, this disclosure relates to a tapered thrust bearing for use in a submersible pump system deployed in an oilfield well environment.

### BACKGROUND

In an oilfield well, an electrical submersible pump (ESP) system may be used to produce production fluids from the well to a surface of the well. ESP systems may be used in well applications where fluid or pressure management is desirable to improve production from a formation surrounding the hydrocarbon wells. The ESP systems may include pumps with a large number of pumping stages to generate sufficient pressure to pump the production fluid to the surface of the well.

In operation, each of the pumping stages of an ESP system may exert a downhole force on pumping stages located further downhole within the ESP system. The downhole force may generally be an opposite force reaction to the uphole pumping of the production fluid through the ESP system. Such downhole forces may result in excess strain on the ESP system, and the excess strain may lead to excessive wear on components of the ESP system.

### BRIEF DESCRIPTION OF THE DRAWINGS

FIG. 1 is a cross-sectional view of an example of a well system that includes an electrical submersible pump system according to some aspects of the present disclosure.

FIG. 2 is a cross-sectional view of a pumping stage and a bottom diffuser stage of the electrical submersible pump system of FIG. 1 according to some aspects of the present disclosure.

FIG. 3 is an exploded perspective view of a flange sleeve and a stationary bushing of the pumping stage or the bottom diffuser of FIG. 2 according to some aspects of the present disclosure.

FIG. 4 is a flowchart of a method for diffusing force within the electrical submersible pump system of FIG. 1 according to some aspects of the present disclosure.

### DETAILED DESCRIPTION

Certain aspects and examples of the disclosure relate to tapered thrust bearings used in electrical submersible pump (ESP) systems downhole in a wellbore. An ESP system can be an artificial lift system for lifting certain volumes of fluid from a wellbore. The tapered thrust bearings can provide a mechanism for the ESP systems to diffuse downhole forces from uphole pumping stages of the ESP system. Diffusing the downhole forces can enhance stability of the ESP systems and can avoid premature wear on components of the ESP systems.

To diffuse the downhole force, the tapered thrust bearing may include a flange sleeve with a tapered mating surface and a stationary bushing with a tapered receiving surface. The stationary bushing, which is attached to a body of a diffuser in the ESP system, may receive the downhole force and diffuse the downhole force into the body of the diffuser. Accordingly, wear on components of the ESP system based on the downhole forces from the pumping stages of the ESP system may be avoided.

Moreover, the tapered mating surface of the flange sleeve and the tapered receiving surface of the stationary bushing may provide self-centering utility to the tapered thrust bearing. For example, the conical shapes of the tapered mating surface and the tapered receiving surface may funnel the flange sleeve into a centralized position around a drive shaft of the ESP system. Because the flange sleeve is self-centering within the stationary bushing, shaft fretting at the tapered thrust bearing may be avoided. As used herein, the term “tapered” is used to indicate that a surface of an object is at an angle that is non-orthogonal (i.e., non-perpendicular) to a central axis of the object. For example, the tapered thrust bearing includes the tapered receiving surface of the stationary bushing and the tapered mating surface of the flange sleeve that are at an angle that is non-orthogonal to a central axis of the tapered thrust bearing.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

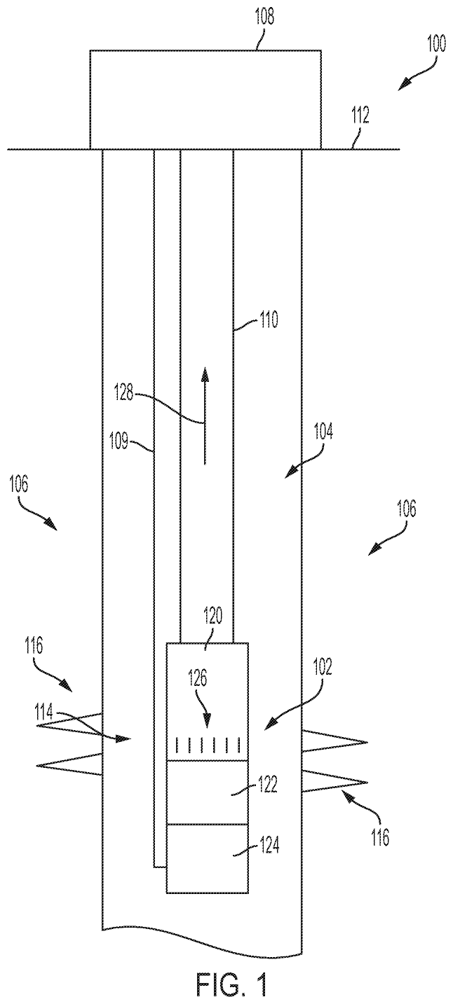

FIG. 1 is a cross-sectional view of an example of a well system 100 that includes an electrical submersible pump (ESP) system 102 positioned within a wellbore 104 according to some aspects. The wellbore 104 may extend through various earth strata such as a hydrocarbon bearing subterranean formation 106. The ESP system 102 may be used in the production of production fluids or other wellbore fluids from the wellbore 104. For example, the ESP system 102 may pump the production fluids from a downhole location within the wellbore 104 to a wellhead 108 located at a surface 112 of the wellbore 104.

As illustrated, the ESP system 102 is suspended from the wellhead 108 with a power cable 109 using tubing 110, which may also be used to produce the production fluid from within the wellbore 104. In an additional example, the ESP system 102 may be suspended from the wellhead 108 when the ESP system 102 is deployed in an inverted orientation within a production liner (not shown). The tubing 110, in addition to providing a flow path for the production fluid to a surface 112 of the wellbore 104, may provide support for the weight of the ESP system 102 when the ESP system 102 is run into the wellbore 104.

The wellhead 108 may provide uphole support for the tubing 110. The wellhead 108 may also electrically couple the power cable 109 to a power source (not shown) located at the surface 112. In this manner, the power from the power source may be transmitted along the power cable 109 to the ESP system 102 located within the wellbore 104.

The ESP system 102 may be deployed to a production zone 114 of the wellbore 104. The production zone 114 may be any area within the wellbore 104 where operators of the ESP system 102 intend to produce production fluids. The production zone 114 may be established based on perforations 116 in the formation 106 that are generated from a hydraulic fracturing or other stimulation operation.

The ESP system 102 may include a pump section 120, a seal section 122, and a motor section 124. The pump section 120 may include fluid intake ports 126 that draw fluid into the ESP system 102, and the pump section 120 may also include fluid discharge ports (not shown) that provide the production fluid into the tubing 110. When the production fluid enters the tubing 110, the production fluid is pumped by the pump section 120 in a direction 128 toward the surface 112. The production fluid may be collected at the wellhead 108 and provided to a storage container (not shown) at the surface 112.

The seal section 122 may include components that reduce a pressure differential between lubricant contained in the motor section 124 and the fluid within the wellbore 104. The motor section 124 may provide the mechanical power that drives operation of the pump section 120. Further, the motor section 124 may receive electrical power from the power cable 109.

While the power cable 109 is illustrated as extending to the motor section 124 from the wellhead 108 on an exterior of the tubing 110, the power cable 109 may also extend to the ESP system 102 from the wellhead 108 within the tubing 110. In such an example, the production fluid may flow in the direction 128 within an annulus between the power cable 109 and an inner-surface of the tubing 110.

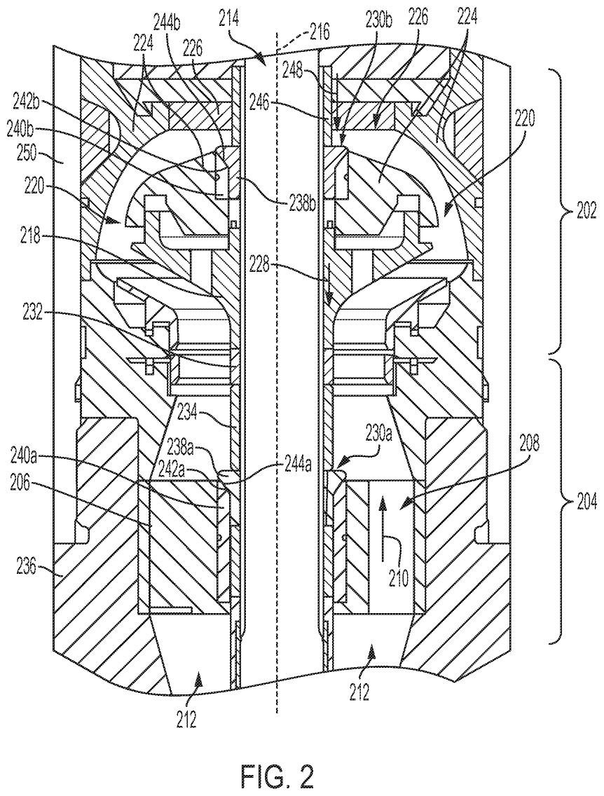

FIG. 2 is a cross-sectional view of a pumping stage 202 and a bottom diffuser stage 204 of the ESP system 102 according to some aspects. The pumping stage 202 and the bottom diffuser stage 204 may be included within the pump section 120 of the ESP system 102. While only an individual pumping stage 202 is illustrated, the pump section 120 of the ESP system 102 may have several pumping stages 202 to provide sufficient lift on the production fluid to pump the production fluid to the surface 112. For example, the pump section 120 may include between 20 and 200 pumping stages 202 to generate the sufficient lift on the production fluid.

The bottom diffuser stage 204 may include a diffuser base 206 that includes one or more flow paths 208 for the flow of fluids in a direction 210 toward the pumping stage 202. The fluids may flow in the direction 210 based on pumping operations of the pumping stages 202. While only the individual flow path 208 is depicted in FIG. 2, an additional flow path 208 may be present in the diffuser base 206 opposite the illustrated flow path 208. Additionally, more flow paths 208 may be present in portions of the diffuser base 206 that are not illustrated in the cross-sectional view of the pumping stage 202.

The production fluid pumped toward the surface 112 of the wellbore 104 may be received at one or more inlet ports 212. The production fluid may flow to the inlet ports 212 from the fluid intake ports 126 of the pump section 120. For example, the pump section 120 may include a flow path (not shown) between the fluid intake ports 126 and the one or more inlet ports 212 of the bottom diffuser stage 204.

The pump section 120 may include a drive shaft 214 that extends along a central axis 216 of the pumping stage 202 and the bottom diffuser stage 204. The drive shaft provides a rotational force that drives rotation of an impeller 218 of the pumping stage 202. When additional pumping stages 202 are installed uphole from the pumping stage 202, the drive shaft 214 also provides the rotational force to drive the rotation of the additional impellers 218 of the additional pumping stages 202. In an example, the drive shaft 214 may rotate between 3000 and 4000 revolutions per minute.

The impeller 218 of the pumping stage 202 imparts kinetic energy to the production fluid received from the bottom diffuser stage 204. A stage diffuser 224 of the pumping stage 202 slows down the production fluid and redirects the production fluid into passages 220 of the stage diffuser 224. By redirecting the production fluid into the passages 220, the production fluid is directed further uphole through one or more outlet ports 226. Further, slowing down the production fluid in the stage diffuser 224 increases the pressure of the production fluid by converting the kinetic energy of the production fluid into pressure energy. Accordingly, each pumping stage 202 of the pump section 120 results in an increase in the pressure energy of the production fluid by converting some of the kinetic energy (e.g., provided by the impellers 218) of the production fluid to pressure energy (e.g., by the stage diffusers 224). In an example, the outlet ports 226 lead to production tubing (e.g., the tubing 110 or a production liner) such that the production fluid is pumped to the surface 112 of the wellbore 104. In another example, the outlet ports 226 lead to additional pumping stages 202, which generate additional pressure energy on the production fluid to force the production fluid toward the surface 112 of the wellbore 104.

The impeller 218 of the pumping stage 202 may generate a force in a direction 228 toward the bottom diffuser stage 204. The force generated in the direction 228 is an opposite force reaction to pumping the production fluid in the direction 210. To prevent such a force from causing wear on the ESP system 102, a thrust bearings 230a may be positioned within the pump section 120 to diffuse the force. For example, the impeller 218 of the pumping stage 202 may generate the force in the direction 228. The force may be applied from the impeller 218 to a spacer 232 and a sleeve 234 surrounding the drive shaft 214 between the impeller 218 and the thrust bearing 230a. The thrust bearing 230a may function as a contact point to diffuse the force from the impeller 218 into the diffuser base 206 and ultimately to a housing 236 of the bottom diffuser stage 204 or to a housing of the pump section 120 surrounding the bottom diffuser stage 204.

The thrust bearing 230a may include a flange sleeve 238a and a stationary bushing 240a. In operation, the flange sleeve 238a may rotate with the drive shaft 214 and receive the downhole force from the sleeve 234. In an example, the flange sleeve 238a is positioned within the stationary bushing 240a. The stationary bushing 240a may include a tapered receiving surface 242a that receives a tapered mating surface 244a of the flange sleeve 238a. In this manner, the flange sleeve 238a may rotate with the drive shaft 214 within the stationary bushing 240a.

By including the tapered receiving surface 242a and the tapered mating surface 244a, the thrust bearing 230a is able to provide more bearing surface area to efficiently diffuse the downhole force without increasing an overall footprint of the thrust bearing 230a when compared to a thrust bearing without the tapered receiving surface 242a and the tapered mating surface 244a. Accordingly, a large bearing surface area relative to a size of the thrust bearing 230a enables the thrust bearing 230a to efficiently diffuse the downhole force from the impeller 218.

In operation, the force may be transferred from the tapered mating surface 244a of the flange sleeve 238a to the tapered receiving surface 242a of the stationary bushing 240a. The stationary bushing may transfer the force radially outward with respect to the central axis 216 and into the diffuser base 206. The diffuser base 206, in turn, may transfer the force to the housing 236. By diffusing the force through the diffuser base 206 and the housing 236, strains placed on the moving components of the pump section 120 are avoided.

Additional pumping stages (not shown) with additional impellers (not shown) may also be positioned uphole from the illustrated pumping stage 202. The additional pumping stages may include structures that are the same as or similar to the illustrated pumping stage 202. The additional impellers of the additional pumping stages may also generate a downhole force on a sleeve 246 in a direction 248 toward the illustrated pumping stage 202. The force generated in the direction 248 is an opposite force reaction to pumping the production fluid in the direction 210 (i.e., in an uphole direction). To prevent such a force from causing wear on the ESP system 102, a thrust bearing 230b may be positioned within the pumping stage 202 to diffuse the force. For example, the additional impeller of the additional pumping stage may generate the force in the direction 248. The force may be applied to the sleeve 246 that surrounds the drive shaft 214 and that extends between the additional impeller and the thrust bearing 230b. The thrust bearing 230b may function as a contact point to diffuse the force from the additional impeller into the stage diffuser 224 and ultimately to a stage housing 250 of the pumping stage 202 or to a housing of the pump section 120 surrounding the pumping stage 202.

The thrust bearing 230b may include a flange sleeve 238b and a stationary bushing 240b. In operation, the flange sleeve 238b may rotate with the drive shaft 214 and receive the downhole force from the sleeve 246. In an example, the flange sleeve 238b is positioned within the stationary bushing 240b. The stationary bushing 240b includes a tapered receiving surface 242b that receives a tapered mating surface 244b of the flange sleeve 238b. In this manner, the flange sleeve 238b may rotate with the drive shaft 214 within the stationary bushing 240b.

By including the tapered receiving surface 242b and the tapered mating surface 244b, the thrust bearing 230b is able to provide more bearing surface area without increasing an overall footprint of the thrust bearing 230b when compared to a thrust bearing without the tapered receiving surface 242b and the tapered mating surface 244b. Accordingly, a large bearing surface area relative to a size of the thrust bearing 230b enables the thrust bearing 230b to efficiently diffuse the force from the additional impeller of the additional pumping stage.

In operation, the force may be transferred from the tapered mating surface 244b of the flange sleeve 238b to the tapered receiving surface 242b of the stationary bushing 240b. The stationary bushing may transfer the force radially outward with respect to the central axis 216 and into the stage diffuser 224. The stage diffuser 224, in turn, may transfer the force to the stage housing 250. By diffusing the force through the stage diffuser 224 and the stage housing 250, strains placed on the moving components of the pump section 120 may be avoided.

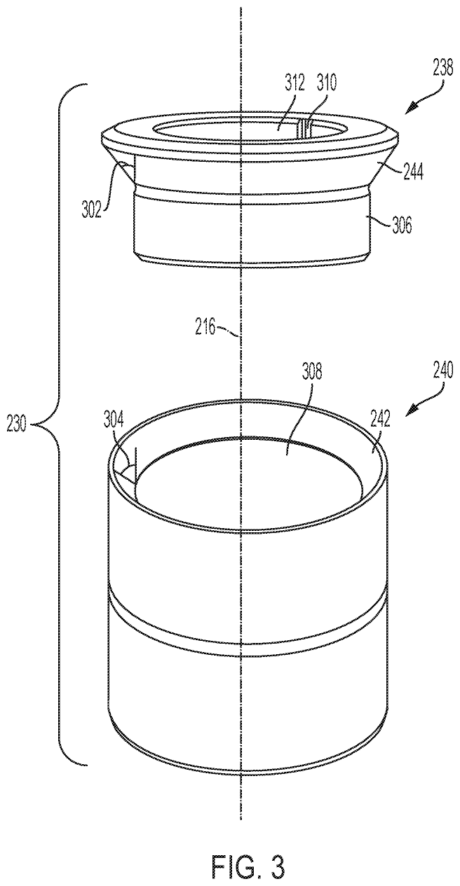

FIG. 3 is an exploded perspective view of the flange sleeve 238 and a stationary bushing 240 of the pumping stage 202 or the bottom diffuser stage 204 according to some aspects. The flange sleeve 238 may include the tapered mating surface 244, and the stationary bushing 240 may include the tapered receiving surface 242. The tapered mating surface 244 and the tapered receiving surface 242 may be conical in shape. As illustrated, the tapered mating surface 244 may include a tapered angle 302, and the tapered receiving surface 242 may include a tapered angle 304. In an example, the tapered angle 302 is equal to the tapered angle 304. In such an example, the tapered angles 302 and 304 may each be between approximately 15 and 75 degrees.

Due to the tapered angles 302 and 304 of the tapered mating surface 244 and the tapered receiving surface 242, the flange sleeve 238 may self-center around the drive shaft 214 within the stationary bushing 240 during operation of the ESP system 102. Because the flange sleeve 238 self-centers within the stationary bushing 240, shaft fretting may be avoided due to a reduction in radial movement of the flange sleeve 238 with respect to the central axis 216.

The flange sleeve 238 may also include a cylindrical section 306 that couples to the tapered mating surface 244. The cylindrical section 306 may extend within a cylindrical section 308 of the stationary bushing 240. The addition of the cylindrical section 306 to the flange sleeve 238 may provide the thrust bearing 230 with additional stability while the flange sleeve 238 rotates within the stationary bushing 240. Clearance between the flange sleeve 238, including the tapered mating surface 244 and the cylindrical section 306, and the stationary bushing 240 when the flange sleeve 238 is positioned within the stationary bushing 240 may be between 6 and 10 thousandths of an inch. In another example, the clearance between the flange sleeve 238 and the stationary bushing 240 when the flange sleeve 238 is positioned within the stationary bushing 240 may be between 2 and 25 thousandths of an inch.

The flange sleeve 238 may also include a key slot 310. The key slot 310 may be located on an inner-surface 312 of the flange sleeve 238, and the key slot 310 may receive a key extending from a portion of the drive shaft 214. By receiving the key of the drive shaft 214, the drive shaft 214 may rotate the flange sleeve 238 within the stationary bushing 240. While the flange sleeve 238 rotates within the stationary bushing 240, the thrust bearing 230 may rely on production fluid flowing in the ESP system 102 to provide lubrication between the flange sleeve 238 and the stationary bushing 240.

As discussed above with respect to FIG. 2, the flange sleeve 238 may receive a downhole force from the impellers 218 positioned uphole from the flange sleeve 238. The downhole force may be diffused to the stationary bushing 240 through an interaction between the tapered mating surface 244 of the flange sleeve 238 and the tapered receiving surface 242 of the stationary bushing 240. When the stationary bushing 240 receives the downhole force, the stationary bushing 240 may diffuse the force radially outward to the stage diffuser 224 or the diffuser base 206. In this manner, the ESP system 102 is able to efficiently absorb the downhole force.

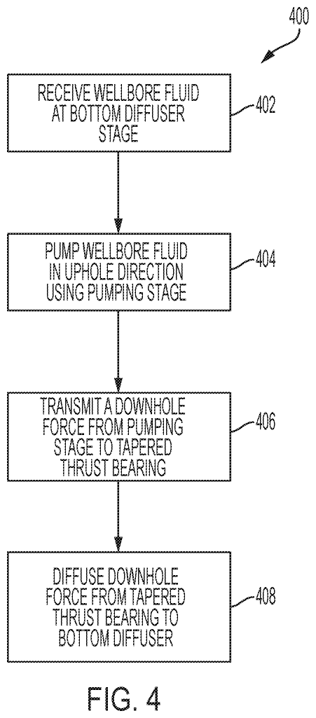

FIG. 4 is a flowchart of a method 400 for diffusing force within the ESP system 102 according to some aspects. At block 402, the method 400 involves receiving wellbore fluid at the bottom diffuser stage 204 of the ESP system 102. As discussed above with respect to FIG. 1, the pump section 120 of the ESP system 102 includes fluid intake ports 126. As wellbore fluid is drawn into the fluid intake ports 126 during a pumping operation, the bottom diffuser stage 204 may receive the wellbore fluid at the inlet ports 212 of the bottom diffuser stage 204.

At block 404, the method 400 involves pumping wellbore fluid in the direction 210 (i.e., an uphole direction toward the surface 112) using the pumping stage 202. The pumping stage 202 may include the impeller 218 that is rotated by the drive shaft 214 to generate pressure on the wellbore fluid to move in the direction 210. The wellbore fluid may exit the pumping stage 202 at the outlet ports 226 to the tubing 110 or to additional pumping stages within the pump section 120.

At block 406, the method 400 involves transmitting a downhole force in the direction 228 from the pumping stage 202 to the tapered thrust bearing 230a in the bottom diffuser stage 204. The downhole force is an opposite reaction response to pumping the wellbore fluid in the direction 210. That is, the downhole force is a resulting force on the ESP system 102 based on pumping the wellbore fluid toward the surface 112 of the wellbore 104.

At block 408, the method 400 involves diffusing the downhole force from the tapered thrust bearing 230a to the diffuser base 206 of the bottom diffuser stage 204. During a pumping operation, the flange sleeve 238a of the tapered thrust bearing 230a may rotate with the drive shaft 214 and the impeller 218. The downhole force may be transmitted from the impeller 218 through the sleeve 234 and to the rotating flange sleeve 238a. The rotating flange sleeve 238a may transfer the downhole force to the stationary bushing 240a, and the stationary bushing 240a diffuses the downhole force into the diffuser base 206 in a direction radially outward from the central axis 214 of the ESP system 102.

Further, because the flange sleeve 238a and the stationary bushing 240a include the tapered mating surface 244a and the tapered receiving surface 242a, respectively, the flange sleeve 238a may be self-centered within the stationary bushing 240a during rotation of the drive shaft 214. For example, the downhole force acting on the flange sleeve 238a drives the flange sleeve 238a into the stationary bushing 240a, and the conical shape of the tapered receiving surface 242a and the tapered mating surface 244a may result in the flange sleeve 238a remaining centralized within the stationary bushing 240a.

While the method 400 is described above with respect to diffusing a downhole force through the bottom diffuser stage 204, the method 400 may also be applied to diffusing a downhole force from additional pumping stages through the tapered thrust bearing 230b and the diffuser 224 of the pumping stage 202. Further, each additional pumping stage 202 in the pump section 120 may also diffuse downhole forces in a similar manner using additional tapered thrust bearings.

In some aspects, systems and devices including tapered thrust bearings for pumping systems are provided according to one or more of the following examples:

As used below, any reference to a series of examples is to be understood as a reference to each of those examples disjunctively (e.g., “Examples 1-4” is to be understood as “Examples 1, 2, 3, or 4”).

Example 1 is a system, comprising: a drive shaft; a diffuser positioned around the drive shaft to transmit a flow of fluid; an impeller that is rotatable with the drive shaft to induce the flow of fluid through the diffuser; and a tapered thrust bearing positionable to receive a downhole force from a pumping stage, the tapered thrust bearing comprising: a flange sleeve positioned around the drive shaft, the flange sleeve comprising a tapered mating surface; and a stationary bushing positioned around the flange sleeve, the stationary bushing comprising a tapered receiving surface to receive the tapered mating surface of the flange sleeve.

Example 2 is the system of example 1, wherein the stationary bushing is positioned to diffuse the downhole force from the pumping stage to the diffuser.

Example 3 is the system of examples 1 or 2, wherein the tapered mating surface is positioned to self-center the flange sleeve within the tapered receiving surface of the stationary bushing.

Example 4 is the system of examples 1-3, wherein the tapered mating surface comprises a first tapered angle and the tapered receiving surface comprises a second tapered angle equal to the first tapered angle.

Example 5 is the system of examples 1-4, wherein the tapered mating surface and the tapered receiving surface are conical.

Example 6 is the system of examples 1-5, wherein the flange sleeve is positionable to rotate with the drive shaft.

Example 7 is the system of examples 1-6, wherein the flange sleeve further comprises: a cylindrical section coupled to the tapered mating surface, the cylindrical section being positionable to extend within the stationary bushing.

Example 8 is the system of examples 1-7, wherein the drive shaft is rotatable at up to 4000 revolutions per minute.

Example 9 is the system of examples 1-8, wherein a clearance between the flange sleeve and the stationary bushing is between 2 and 25 thousandths of an inch.

Example 10 is the system of examples 1-9, further comprising: a bottom diffuser stage positionable to receive the fluid from a wellbore, the bottom diffuser stage comprising: a bottom diffuser positioned around the drive shaft to transmit the flow of fluid; an additional tapered thrust bearing positionable to receive an additional downhole force from the impeller, the additional tapered thrust bearing comprising: an additional flange sleeve positioned around the drive shaft, the additional flange sleeve comprising an additional tapered mating surface.

Example 11 is the system of examples 10, wherein the diffuser receives the flow of fluid from the bottom diffuser stage.

Example 12 is the system of examples 10 or 11, wherein the additional tapered thrust bearing is positionable to diffuse the additional downhole force into the bottom diffuser.

Example 13 is a tapered thrust bearing, comprising: a stationary bushing comprising: a cylindrical section positionable around a drive shaft of an electrical submersible pumping system; and a tapered receiving surface at an end of the cylindrical section, the tapered receiving surface positionable to interact with a flange sleeve within the stationary bushing; and the flange sleeve positionable around the drive shaft and within the stationary bushing, the flange sleeve comprising: a tapered mating surface that interacts with the tapered receiving surface of the stationary bushing to center the flange sleeve within the stationary bushing.

Example 14 is the tapered thrust bearing of examples 13, wherein the flange sleeve further comprises: an additional cylindrical section coupled to the tapered mating surface, the additional cylindrical section positionable to extend within the cylindrical section of the stationary bushing.

Example 15 is the tapered thrust bearing of examples 13 or 14, wherein the tapered receiving surface comprises a first tapered angle, and the tapered mating surface comprises a second tapered angle equal to the first tapered angle.

Example 16 is the tapered thrust bearing of example 15, wherein first tapered angle and the second tapered angle are between 15 and 75 degrees.

Example 17 is the tapered thrust bearing of examples 13-16, wherein the tapered receiving surface and the tapered mating surface are each conical.

Example 18 is the tapered thrust bearing of examples 13-17, wherein the flange sleeve further comprises a key slot positionable to mate with a key of the drive shaft such that the drive shaft rotates the flange sleeve.

Example 19 is a method, comprising: receiving wellbore fluid at a bottom diffuser stage of an electrical submersible pump (ESP) system; pumping the wellbore fluid in an uphole direction using a pumping stage of the ESP system; transmitting a downhole force from the pumping stage to a tapered thrust bearing of the bottom diffuser stage, the tapered thrust bearing comprising a tapered mating surface on a flange sleeve and a tapered receiving surface on a stationary bushing; and diffusing the downhole force from the stationary bushing of the tapered thrust bearing to a bottom diffuser of the bottom diffuser stage.

Example 20 is the method of example 19, further comprising: driving an impeller of the pumping stage with a drive shaft to pump the wellbore fluid in the uphole direction; rotating the flange sleeve of the tapered thrust bearing with the drive shaft; and self-centering the flange sleeve within the stationary bushing.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system, comprising:
a drive shaft;
a diffuser positioned around the drive shaft to transmit a flow of fluid;
an impeller that is rotatable with the drive shaft to induce the flow of fluid through the diffuser; and
a tapered thrust bearing positionable to receive a downhole force from a pumping stage, the tapered thrust bearing comprising:
a flange sleeve positioned around the drive shaft, the flange sleeve comprising a tapered mating surface; and
a stationary bushing positioned around the flange sleeve, the stationary bushing comprising a tapered receiving surface to receive the tapered mating surface of the flange sleeve.

2. The system of claim 1, wherein the stationary bushing is positioned to diffuse the downhole force from the pumping stage to the diffuser.

3. The system of claim 1, wherein the tapered mating surface is positioned to self-center the flange sleeve within the tapered receiving surface of the stationary bushing.

4. The system of claim 1, wherein the tapered mating surface comprises a first tapered angle and the tapered receiving surface comprises a second tapered angle equal to the first tapered angle.

5. The system of claim 1, wherein the tapered mating surface and the tapered receiving surface are conical.

6. The system of claim 1, wherein the flange sleeve is positionable to rotate with the drive shaft.

7. The system of claim 1, wherein the flange sleeve further comprises:
a cylindrical section coupled to the tapered mating surface, the cylindrical section being positionable to extend within the stationary bushing.

8. The system of claim 1, wherein the drive shaft is rotatable at up to 4000 revolutions per minute.

9. The system of claim 1, wherein a clearance between the flange sleeve and the stationary bushing is between 2 and 25 thousandths of an inch.

10. The system of claim 1, further comprising:
a bottom diffuser stage positionable to receive the fluid from a wellbore, the bottom diffuser stage comprising:
a bottom diffuser positioned around the drive shaft to transmit the flow of fluid;
an additional tapered thrust bearing positionable to receive an additional downhole force from the impeller, the additional tapered thrust bearing comprising:
an additional flange sleeve positioned around the drive shaft; the additional flange sleeve comprising an additional tapered mating surface.

11. The system of claim 10, wherein the diffuser receives the flow of fluid from the bottom diffuser stage.

12. The system of claim 10, wherein the additional tapered thrust bearing is positionable to diffuse the additional downhole force into the bottom diffuser.

13. A tapered thrust bearing, comprising:
a stationary bushing comprising:
a cylindrical section positionable around a drive shaft of an electrical submersible pumping system; and
a tapered receiving surface at an end of the cylindrical section, the tapered receiving surface positionable to interact with a flange sleeve within the stationary bushing; and
the flange sleeve positionable around the drive shaft and within the stationary bushing, the flange sleeve comprising:
a tapered mating surface that interacts with the tapered receiving surface of the stationary bushing to center the flange sleeve within the stationary bushing.

14. The tapered thrust bearing of claim 13, wherein the flange sleeve further comprises:
an additional cylindrical section coupled to the tapered mating surface, the additional cylindrical section positionable to extend within the cylindrical section of the stationary bushing.

15. The tapered thrust bearing of claim 13, wherein the tapered receiving surface comprises a first tapered angle, and the tapered mating surface comprises a second tapered angle equal to the first tapered angle.

16. The tapered thrust bearing of claim 15, wherein first tapered angle and the second tapered angle are between 15 and 75 degrees.

17. The tapered thrust bearing of claim 13, wherein the tapered receiving surface and the tapered mating surface are each conical.

18. The tapered thrust bearing of claim 13, wherein the flange sleeve further comprises a key slot positionable to mate with a key of the drive shaft such that the drive shaft rotates the flange sleeve.

19. A method, comprising:
receiving wellbore fluid at a bottom diffuser stage of an electrical submersible pump (ESP) system;
pumping the wellbore fluid in an uphole direction using a pumping stage of the ESP system;
transmitting a downhole force from the pumping stage to a tapered thrust bearing of the bottom diffuser stage, the tapered thrust bearing comprising a tapered mating surface on a flange sleeve and a tapered receiving surface on a stationary bushing; and
diffusing the downhole force from the stationary bushing of the tapered thrust bearing to a bottom diffuser of the bottom diffuser stage.

20. The method of claim 19, further comprising:
driving an impeller of the pumping stage with a drive shaft to pump the wellbore fluid in the uphole direction;
rotating the flange sleeve of the tapered thrust bearing with the drive shaft; and
self-centering the flange sleeve within the stationary bushing.
